(19) United States
(12) Patent Application Publication
(10) Pub. No.: US 2006/0078843 A1
(43) Pub. Date: Apr. 13, 2006

(54) System

(75) Inventor: Johnny Lundberg, Karlskoga (SE)

Correspondence Address: WHITE, REDWAY & BROWN LLP, 1217 KING STREET, ALEXANDRIA, VA, 22314, US

(73) Assignee: Akzo Nobel Coatings International B.V., Arnhem (NL)

(21) Appl. No.: 11/238,149

(22) Filed: Sep. 29, 2005

Related U.S. Application Data
(60) Provisional application No. 60/617,210, filed on Oct. 12, 2004.

(51) Int. Cl. G01N 31/00

(52) U.S. Cl. 433/34

(57) ABSTRACT

The invention relates to a method of determination of process parameters of a chemical process carried out in a chemical reactor. It comprises passing a sample of a process medium of said chemical process into a side-loop and isolating said side-loop from the process medium. The sample is circulated in said side-loop and tempered to a desired temperature. A measurement of at least one process parameter is made on said sample at the desired temperature. The invention also relates to a system for performing the method, and the use thereof.

The present invention relates in general to a method for measuring a plurality of parameters in chemical processes where tempered measurements on liquid media is a requirement and a system therefore. The system is particularly suitable for use in resin manufacturing.

### BACKGROUND OF THE INVENTION

Monitoring of process parameters of chemical production processes by means of automated operating systems is well-known in the art.

Some monitoring systems require human intervention, including manual sampling of the liquid medium for further processing in separate measurements or analysis equipment, possibly in a laboratory remote from the sampling site. These systems are labour-intensive, and the results from them are often not swiftly obtained.

Others involve automatic, non-tempered in-line systems including pumping the medium to be analysed in a loop, in which relevant field equipment has been mounted. The measurements are carried out at about the same temperature that prevails inside the reactor. The temperature of the medium in these systems is not adjusted. The measurement temperature may play a considerable role to obtain accurate results. This is the case when measuring e.g. the viscosity, pH and many other process parameters. The viscosity of the reaction medium of a solution of two reactants in a reaction vessel may be very similar at an elevated reaction temperature but fairly different at a lower temperature. The measurement at a lower temperature may then provide more accurate results. One example of non-tempered technology is disclosed in U.S. Pat. No. 6,635,224 illustrating an on-line polymer monitoring apparatus for rapid determination of various polymer properties.

Thus, there is a need for more flexible systems enabling accurate measurements at temperatures different from the reactor temperature. It would also be desirable to provide a system enabling rapid switching between measurements in-line and on-line. It would also be desirable to provide a system enabling smooth and continuous monitoring. It would also be desirable to provide a system preventing clogging of the equipment making up the system as well as loss of reaction material. It would also be desirable to provide a system enabling a plurality of measurement of various process parameters. It would also be desirable to provide a simplified and rapid monitoring system enabling simultaneous in-line and on-line measurements of process parameters. The present invention intends to provide such a system.

### THE INVENTION

The term “in-line system”, as used herein, refers to a system where a sample flow of a process medium, the parameters of which is to be determined, is passed through a side-loop in which measurement equipment is arranged. Thus, the temperature of the sample flow will be essentially the same as in the reactor, and is thus not adjusted.

The term “on-line system”, as used herein, refers to a system in which a sample flow of a process medium is withdrawn from the reactor and passed into a closed loop, separated from the reactor, wherein means for tempering the medium is provided, thus enabling measurements to be made at an adjusted and controlled temperature, that differs from the reactor temperature. It has been found that this type of closed loop provides for much more accurate measurements compared to open continuous loops which continuously circulates flow back to the reactor.

By the term “process medium”, as referred to herein, is meant to encompass all reactants taking part or other components or substances present in the reactor where the chemical process is performed such as solvents, solutions etc.

By the term “sample, as used herein, is meant a part or fraction of the process medium withdrawn from the reactor used for measurements of process parameters.

The method of determination of process parameters is further defined in claim 1, and a system for carrying out such determination is defined in claim 6. Preferred embodiments of the method and the system are further defined in the remaining appended claims.

The invention will now be described in more detail with reference to the attached drawings.

### BRIEF DESCRIPTION OF THE DRAWINGS

FIG. 1 is a schematic illustration of an automated, tempered combined in-line/on-line system according to one embodiment of the present invention;

FIG. 2 shows viscosity vs. temperature curves for two resins;

FIG. 3a is a side view of a sieve for use in the system according to the invention; FIG. 3b is a view from the outlet end of the sieve.

### DETAILED DESCRIPTION OF PREFERRED EMBODIMENTS

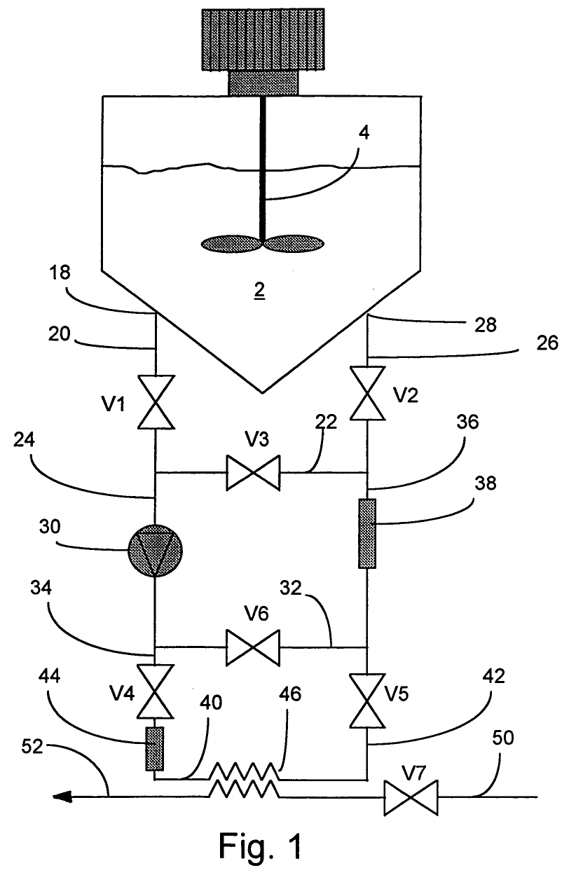

FIG. 1 shows a system comprising a batch reactor (reactor vessel) 2 in which a manufacturing process of resin is carried out. Agitating means 4 driven by a suitable motor is provided in the reactor vessel.

At the bottom of reactor vessel 2, an outlet 18 is located to which a pipe segment 20 is connected. A valve V1 is mounted in pipe segment 20. Pipe segment 20 is diverted in two pathways by pipe segments 22 and 24 respectively. In pipe segment 22, a valve V3 is mounted, and a first loop formed by pipe segments 20 and 22 is completed by a further pipe segment 26, connected to inlet 28 at the bottom of reactor vessel 2, which inlet is preferably not too close to outlet 18. In pipe segment 26, a valve V2 is mounted.

A means for circulating the sample, preferably a pump 30, for passing sample medium through the system is provided in pipe segment 24. Segment 24 is diverted in two pathways by pipe segments 32 and 34. In segment 32 a valve V6 is provided. Segment 32, 22, 24, and 36 complete a second loop. In segment 36, a measurement box 38 is provided further described below. The side-loop formed by pipe segments 20, 24, 32, 36 and 26 forms an “in-line measurement loop”.

A third loop is formed by pipe segments 20, 24, 34, 40, 42, 36, and 26. In segment 34, a valve V4 and a sieve 44 are provided, the function and design of which will be further illustrated below. In segment 40, there is provided a heat exchanger 46 for tempering a passing sample to a desired temperature. Finally, a valve V5 is provided in the segment 42. The isolated or separated side-loop formed by pipe segments 22, 24, 34, 40, 42 and 36 will be referred to as an “on-line measurement loop”.

Cooling medium may be passed through heat exchanger 46 via a suitable valve V7 from inlet pipe 50 to outlet pipe 52.

Thus, there are two side-loops provided in the system illustrated in FIG. 1, both encompassing a common pump 30, and measurement box 38, namely the in-line loop and the on-line loop. The first loop made up of pipe segments 20, 22, and 26 has no function per se.

In an illustrated example below, the entire loop system has a capacity of about 40 litres of sample, and is contemplated to be used with a reactor having a volume of 50 m³. Thus, the sample constitutes about 0.08% of the total reactor volume. Examples of suitable sensors for pH and viscosity measurements respectively are TBI-Bailey (pH) and BTG-Källe (viscosity). Other suitable sensors may include e.g. a commercial turbidity sensor such as a Dual Beam Scattered-Light Sensor from Optek-Danulat, GmbH—Essen, Germany as well as NIR spectroscopy equipment for collecting spectrometrical data from process media, e.g. an Interactance Immersion System 6500 from FOSS. A plate heat exchanger is suitably used to temper the process media. Measurement box 38 suitably comprises an elongated tube, in which the sensor/sensors preferably are mounted to measure the temperature of the sample and preferably also to monitor the cooling capacity of the heat exchanger regulating the temperature of the sample. Variation in cooling capacity can thus be monitored and cleaning of the cooler may be made accordingly. Preferably, two sensors are mounted in either end of the box. During tempering, a volume change will occur, leading to pressure changes. Such pressure/volume changes are preferably adjusted by keeping valve V1 open during the tempering phase. The compensators are essentially comprised of rubber elements having the necessary flexibility. These compensators act to reduce vibrations in the measurement box, which is beneficial for the viscosity measurement in particular. The means for circulating the sample, preferably a pump, may be shut off when the tempering phase has been completed and the measurement of the process parameters is to begin. This is advantageous in the sense that the process parameters, e.g. the viscosity, the pH, conductivity, turbidity or spectrometrical data can be measured while the sample is standing still in the pipe segments. The sample flow may otherwise, if flowing through the measuring equipment, disturb the measurements and render them less accurate. This may be due to particles dissolved in the sample flow. The flow also may cause turbulance, physical forces on the sensor. Further contaminants besides particles, e.g. bubbles, wood chips in certain production lines, can be wholly or partially eliminated. Particles and the like can also be eliminated by means of filter means as further disclosed herein.

The invention will be now be illustrated by an example. Let us assume an application such as the manufacture of a urea formaldehyde resin. The process could be according to the following scheme:

1. loading of formaldehyde solution (50% w/w) and adjustment of the pH to 8.0-8.6 using sodium hydroxide in a suitable reactor.

2. loading of urea to a formaldehyde/urea (F/U) molar ratio of 2.0-2.2 and control/adjustment of the pH to 8.0-8.6. Raising the temperature to 80° C. and allowing the reaction to proceed for 10 minutes.

3. Adjusting the pH to 5.2-5.5 with formic acid and raising the temperature to 95° C. (exothermic reaction) and letting the condensation reaction proceed to a viscosity of 400-500 mPas.

4. Terminating the condensation reaction by increasing the pH to 8.0-8.6 and adding urea to a final molar ratio F/U of 1.0-1.2. Evaporation to a dry content of 65-70 wt %.

5. Control of pH (8.0-8.6) and emptying the reactor.

As can be seen from this scheme above, a pH adjustment is carried out in the beginning of the process (step 1). A pH determination is made again during step 2 and initially in step 3 after which the viscosity is measured. In order to get high accuracy for the viscosity, measurements should be made at 25° C., the process temperature in the reactor vessel during the condensation reaction being 90° C. In step 4, again pH is determined. Thus, this application requires measurements at two separate temperatures, and the switching between high and low temperature measurements should preferably be very rapid.

For the pH measurements (steps 1, 2 and 4), “in-line mode” is used. Thereby, the in-line measurement loop defined by pipe segments 20, 24, 32, 36 and 26 is established by opening valves V1, V2, V6, and closing valves V4, V5, and V3. Pump 30 pumps process medium from reactor 2 through the in-line loop and the medium will thus pass through measurement box 38 where a pH meter is located. The medium is pumped through box 38 for a time sufficient for allowing the pH reading to stabilise. Then the reading is taken as an indication of the pH prevailing in the reactor.

The pH meter (not shown as such) is thus located inside measurement box 38. Sometimes, glass material comprised in the measurement head of the pH meter is affected by the process conditions, especially the composition of the process medium, and compensations for variations may be made by means of controlling software.

For the viscosity measurement (step 3), the “on-line mode” is used. Thereby the on-line measurement loop defined by pipe segments 22, 24, 34, 40, 42, and 36 is established by closing valves V1, V2 and V6, and opening valves V3, V4 and V5. In this mode, the process medium sample is pumped from the reactor into the above defined loop to fill it with the medium to be considered, and when the “on-line loop” defined above is filled, valves V1 and V2 are closed. Then the medium is circulated through the heat exchanger 46. The heat exchanger is fed with a suitable cooling medium through inlet 50, until the temperature has reached a desired level. The flow of cooling medium may be switched off with valve V7. A temperature sensor (not shown) is also located inside measurement box 38. Of course, the pH may be continuously monitored during tempering if desired.

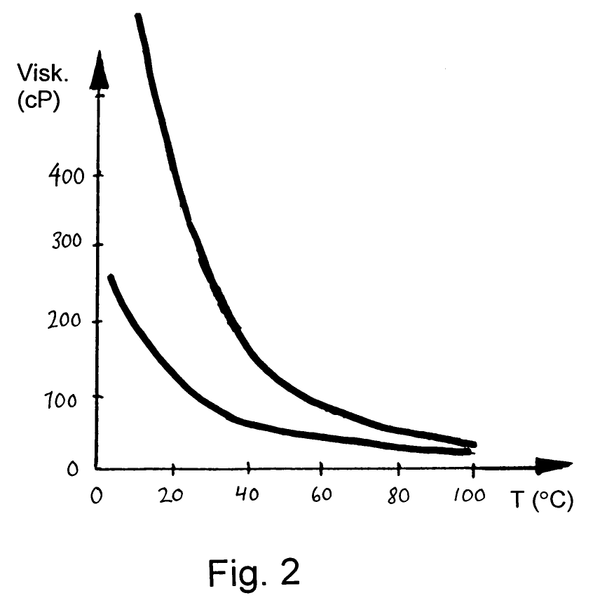

As mentioned above, tempering is especially important for viscosity measurements but also when measuring other temperature sensitive parameters. At high temperatures, the viscosity differs very little between different substances, which fact is evident from FIG. 2 showing viscosity vs. temperature for two different resins. Clearly, the difference is almost negligible at 100° C., whereas at room temperature (approximately 20° C.), the difference is substantial. Thus, measurements at higher temperatures require extreme accuracy in the equipment to be used. Even if the equipment is accurate, the measurement is affected by various phenomena, e.g. vibrations, small solid particles present in the flow etc. These relatively small disturbances may still have a very large influence on the measurements. It has been found that only 1-5 minutes may be required before a reliable mesurement can be performed on a tempered sample which enables accurate monitoring. In the process example above, only in-line measurement and on-line tempering/measurement modes were discussed.

However, a number of other modes are operable for various purposes. Namely, when a viscosity measurement has been performed, a certain time has inevitably lapsed, and the process medium will have changed. In order to obtain a current value of the viscosity, the material locked inside the closed on-line loop must be replaced by a fresh sample of process medium. This will be referred to as the exchange phase of the on-line function. For this purpose, valve V3 is closed and valves V1 and V2 are opened, thereby emptying the loop through reactor vessel inlet 28 and pumping fresh sample into the loop through reactor vessel outlet 18. This exchange phase is terminated when the temperature at the inlet 28 equals the temperature at the outlet 18. During this exchange phase, the heat exchanger is preferably inoperative, i.e. valve V7 is switched off to prevent cooling medium to pass through the heat exchanger. At this time, i.e. when the inlet and outlet temperatures equal each other, the system is ready for another on-line mode operation (tempering/measuring).

In certain embodiments, such as when using a sensor with a relatively slow equilibrating time (e.g. pH meter), it may be desirable to isolate a sample flow without tempering it in the heat exchanger. This may be done by closing valves V1, V2, V4 and V5, and opening valves V3 and V6. Thus, the sample is circulated through the measurement box 38 for a time sufficient for the sensor in question to reach an equilibrium state. This function will be referred to as a “non-tempering function”.

It is possible to let the sample circulate without tempering for a period of time sufficient for a pH meter to equilibrate, while the remaining sample in the now closed off loop is stagnant, but will nevertheless continue to cool down to some extent. Thus, when the equilibrium pH measurement has successfully been made, the circulation in the tempering loop is restarted, and now the time to reach the desired temperature will be rather short, and a time saving has been achieved. It has been found that switching from the tempering function to the non-tempering function can be performed in only about 15-60 seconds which provides for very quick and efficient monitoring by measuring parameters at both reactor temperature as well as tempered reactor samples.

Also, it is of course necessary to clean the system at times between running batches. For cleaning purposes there are a number of possible modes of operation. Such cleaning does not form part of the invention per se, and should in fact be tailored for each individual process set up, like an ordinary washing machine setting.

Since the various loops for the different measurement modes form sub-loops of the entire side-loop system, and since they are inter-connected by means of a number of valves, it is possible to perform practically instantaneous switching between the various modes, simply by opening and closing appropriate valves. As a consequence, the control of a chemical process where a number of different parameters need to be monitored within short time frames is greatly simplified and made much more efficient.

Frequently, the process medium is contaminated by small particles, fibres and other debris that has managed to pass the pump without having been comminuted to a sufficiently small size. The distance between the plates in the heat exchanger is critical (in the case of a plate heat exchanger). Preferably, the distance is commonly about 4 mm, but may of course vary among different manufacturers.

In order to prevent such debris from obstructing the space between the plates, a sieve may be provided upstream the heat exchanger. This sieve is not necessary for the function of the system according to the invention, but is primarily provided as a security precaution. However, measurements of e.g. viscosity could be adversely affected by the presence of the mentioned objects in the flow, and thus the sieve may nevertheless be beneficial for the successful operation of the invention.

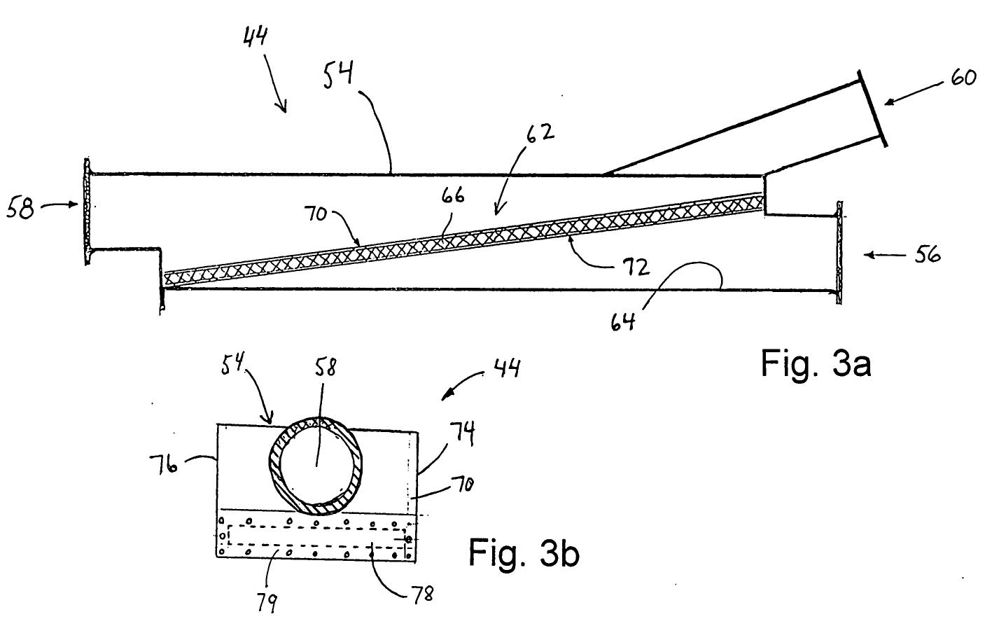

The sieve, shown in FIGS. 3a and 3b, and generally designated 44 comprises an elongated box 54 made of acid proof steel, and has a generally rectangular cross section.

It is provided with an inlet 56 and an outlet 58, and is mounted in the pipe segment 34 leading up to the heat exchanger 46 (see FIG. 1). A further inlet 60 for rinsing purposes is provided at an inclination, entering the box 54 from above. Inside sieve box 54 a mesh structure 62 is provided. The mesh is arranged at an angle inside the box, such that the incoming liquid will pass mesh structure 62 from beneath. In this way, any particles etc. that will be caught by mesh structure 62, will settle onto the bottom surface 64 of box 54, thus lowering the risk of clogging the mesh. The mesh structure 62 comprises a mesh 66, mounted in a thin acid proof frame structure (not shown in the figure). Inside box 54, there are provided two ridges 70 and 72 on each vertical wall 74 and 76 in box 54. The ridges extend from the bottom of the box at the outlet end diagonally upwards to the upper part at the inlet end of the box, and thus, these pairs of ridges form a respective guide means in which the assembly of mesh and frame is inserted through an opening 78 (indicated with dashed lines) at the outlet end of box 54.

The opening is covered by a hood 79 that may be secured in a leak tight fashion by suitable fastening means and suitable gasket means. Thus, replacement of the sieve structure as a whole is not necessary, but it will suffice to replace mesh structure 62, which is an easy operation.

In the foregoing description, the invention has been described by example where, inter alia pH and viscosity have been the parameters of interest. The skilled man will realise that the principle underlying the invention may be used also for other parameters in any process wherein control of parameters is required in a tempered state, and where rapid switching between measurements made is required, without departing from the inventive concept as brought out in the appended claims.

1. A method of determination of at least one process parameter of a chemical process carried out in a reactor, comprising
(a) passing a sample of a process medium of said chemical process into a side-loop and isolating said sample from the remaining process medium in said reactor;
(b) circulating said sample in said side-loop and tempering it therein to a desired temperature;
(c) performing a measurement of at least one process parameter of said sample at the desired temperature.

2. A method according to claim 1, wherein tempering is achieved by operating a heat exchanger in said side-loop.

3. A method according to claim 1 comprising circulating a fraction of said sample in isolation from the remainder of the sample in a sub-loop of said side-loop while said remainder of the sample is maintained in a stagnant state, whereby no tempering is performed in said sub-loop, and whereby one or more parameters are measured in the sample of said sub-loop.

4. A method according to claim 1, wherein the volume of the sample is 1 volume % of the process medium in the reactor.

5. A method according to claim 1, further comprising
d) circulating a process medium in a closed sub-loop of said side-loop without tempering;
e) optionally performing a measurement at reactor temperature in said subloop.

6. A system for measuring process parameters of a chemical process carried out in a reactor comprising an outlet and an inlet; a side-loop connected to said reactor via an outlet and an inlet enabling passage of a sample of a process medium from said reactor to said side-loop and back to said reactor, means for circulating said sample, valves for isolating said sample in said side-loop from the process medium in said reactor, means for tempering said sample in said side-loop to a desired temperature; and means for measuring at least one process parameter at said desired temperature in said side-loop.

7. A system according to claim 6, wherein a measurement box is provided in said side-loop, in which box at least one sensor for performing desired measurements is provided.

8. A system according to claim 6, wherein said side-loop comprises a sub-loop having no means for tempering, said sub-loop being operable in isolation from the side-loop.

9. A system according to claim 6, wherein a measurement box is provided in said side-loop which is arranged such that it is employable when the system is operated with a sub-loop having no means for tempering.

10. A system according to claim 6 further comprising sieve means provided in said side-loop upstream the means for tempering, said sieve comprising a casing; said casing being provided with an inlet and an outlet, and being mounted in a pipe segment; a mesh structure comprising a mesh and a frame supporting said mesh provided inside said casing.

11. A system according to claim 6, wherein a casing is provided with a pair of ridges on respective vertical walls in said box, said ridges extending from the bottom of the casing at an outlet end diagonally upwards to the upper portion at the inlet end of the casing, said pair of ridges forming respective guide means in which an assembly of a mesh and a frame is insertable through an opening at the outlet end of casing.

12. A method according to claim 1 for controlled production of resins.
